(19) United States
(12) Patent Application Publication
(10) Pub. No.: US 2015/0273966 A1
(43) Pub. Date: Oct. 1, 2015

(54) BALL JOINT

(71) Applicants: Klas Nilsson, Lund (SE); Simon Barth, Niederbipp (CH); Ove Kullborg, Vasteras (SE); Ove Ode, Vasteras (SE); Tobias Björnhov, Falsterbo (SE)

(72) Inventors: Klas Nilsson, Lund (SE); Simon Barth, Niederbipp (CH); Ove Kullborg, Vasteras (SE); Ove Ode, Vasteras (SE); Tobias Björnhov, Falsterbo (SE)

(73) Assignee: GÜDEL GROUP AG, Langenthal (CH)

(21) Appl. No.: 14/402,288

(22) PCT Filed: May 21, 2012
(86) PCT No.: PCT/CH2012/000115

§ 371 Date: Apr. 15, 2015

(51) Int. Cl. B60G 7/00

(52) U.S. Cl. CPC B60G 7/005

(57) ABSTRACT

The invention refers to a ball joint comprising a ball with an attached arm, a proximal shell having a wear surface, and a distal shell having a wear surface and having an opening for passage of the arm. The ball is held between the wear surface of the proximal shell and the wear surface of the distal shell, while the arm is passed through the opening in the distal shell. Furthermore, the ball joint comprises a biasing element by which the proximal shell and the distal shell are biased with a force towards each other, wherein the biasing element is adjustable in order to adjust the force with which the proximal shell and the distal shell are biased towards each other.

### TECHNICAL FIELD

The invention relates to a ball joint comprising a ball with an attached arm, a proximal shell having a wear surface, and a distal shell having a wear surface and having an opening for passage of the arm. The ball is held between the wear surface of the proximal shell and the wear surface of the distal shell and the arm is passed through the opening in the distal shell. Furthermore, the ball joint comprises a biasing element by which the proximal shell and the distal shell are biased with a force towards each other.

### BACKGROUND ART

Ball joints pertaining to the above mentioned technical field are known. For example, one such ball joint is described in WO 2007/084901 A2 of Federal-Mogul Corporation. In this example, the ball joint comprises a ball with an attached arm, an inner bearing and an outer bearing both having a wear surface, and a biasing element made from a Belleville washer type spring. Furthermore, the ball joint comprises a socket which is closed at its inner end and which provides an opening at its outer end. The ball joint is assembled in that in a first step, the biasing element is inserted into the socket. In a second step, the inner bearing is inserted into the socket, followed by the ball with the attached arm and the outer bearing. In this arrangement, the inner bearing rests on the biasing element and the ball is kept between the wear surfaces of the inner and the outer bearing, while the arm which is attached to the ball is passed through an opening in the outer bearing. In order to finalise the ball joint's assembly, the outer bearing is pressed into the socket against the preload force of the biasing element and the outer border of the socket is folded inside towards a centre of the socket's opening. Due to the folded border, the outer bearing is kept in place inside the socket and the compression of the ball between the inner and the outer bearing is maintained for providing a stiffness of the ball joint.

The disadvantage of this known ball joint is that due to production caused deviations in the shape and the size of the ball and the inner and outer bearing as well as due to the limiting accuracy with which border is folded inwards, the compression of the ball between the inner and the outer bearing varies for every ball joint.

### SUMMARY OF THE INVENTION

It is the object of the invention to create a ball joint pertaining to the technical field initially mentioned which can be produced in a number such that all the ball joints have a same compression of the ball between the inner and the outer bearing and thus have a same stiffness.

The solution of the invention is specified by the features of claim 1. According to the invention, the biasing element is adjustable in order to adjust the force with which the proximal shell and the distal shell are biased towards each other.

This has the advantage that the ball joint's stiffness is optimally controllable.

In a first preferred embodiment, the biasing element is adjustable before the ball joint is assembled. This embodiment is particularly advantageous if the ball joint's stiffness is to be tuned only once before or during assembly of the ball joint. In this case, the ball joint may be constructed simpler and thus cheaper.

In a second preferred embodiment, the biasing element is adjustable in the assembled ball joint. This has the advantage that it enables to tune the stiffness of the ball joint after the assembly of the ball joint. Consequently, it allows for adapting the ball joint to a very specific and sensitive application and even enables to adapt the assembled ball joint alternating to two or more different, sensitive applications.

In a third preferred embodiment, the biasing element is adjustable before the ball joint is assembled as well as adjustable when being built into the assembled ball joint. Similar to the second preferred embodiment, this has the advantage that it is possible to tune the stiffness of the ball joint after assembling the ball joint. Consequently, it allows for adapting the ball joint to a very specific and sensitive application as well as alternating to two or more different, sensitive applications. Furthermore, the third preferred embodiment has the advantage that the biasing element may be pre-adjusted before the ball joint is assembled in order to facilitate the adjustment of the ball joint to the needs of the ball joint's final employment.

Advantageously, the ball joint comprises a socket, wherein the ball, the wear surface of proximal shell and the wear surface of the distal shell are arranged in the socket. Hereby, one of the proximal shell or the distal shell or both the proximal shell and the distal shell may be arranged moveably inside the socket. If only one of the proximal shell and the distal shell is arranged moveably, the other one of the proximal shell and the distal shell may be arranged fixedly in the socket or attached fixedly to the socket. In one example for the latter case, the respective proximal or distal shell is screwed to an end of the socket.

In another example, the respective proximal or distal shell is soldered or glued to an end of the socket. In such cases of a fixedly arranged shell, the respective shell may be considered as part of the shell. In the same sense, one of the proximal shell and the distal shell may be made of a same piece as the socket. In case both the proximal shell and the distal shell are made of a same piece as the socket, the socket may comprise two elements such that one element comprises the proximal shell, while the other element comprises the distal shell.

All these variations where the ball joint comprises a socket and where the ball, the wear surface of the proximal shell and the wear surface of the distal shell are arranged in the socket have the advantage that the bearing of the ball is well protected against external influences.

Alternatively, the ball joint may not comprise a socket.

If the ball joint comprises a socket, the socket and the distal shell with the opening for passage of the arm are preferably made from a same one piece. In a preferred variant, the socket and the proximal shell are made from a same one piece. In this latter variant, the socket and the distal shell may be made from different pieces, while in the previous mentioned variant, the socket and the proximal shell may be made from different pieces. Both variants have the advantage the construction of the ball joint is simpler.

Alternatively, the socket, the distal shell and the proximal shell, respectively, may be made from different pieces.

If the ball joint comprises a socket, the proximal shell is advantageously an element which is mounted in the socket. In a preferred variant hereto, the distal shell is an element which is mounted in the socket. Both variants have the advantage that the respective shell is protected by the socket. This advantage remains independent of whether only one of the variants is applied or whether both variants are applied in combination.

Alternatively, neither the proximal shell nor the distal shell is mounted in the socket.

If the ball joint comprises a socket and if the proximal shell is an element which is mounted in the socket, the proximal shell is advantageously movable in lateral direction relatively to the socket for adjusting its position relative to the ball. Similarly, if the ball joint comprises a socket and if the distal shell is an element which is mounted in the socket, the distal shell is advantageously movable in lateral direction relatively to the socket for adjusting its position relative to the ball. In a preferred variant, both the proximal shell and the distal shell are movable in lateral direction relatively to the socket for adjusting its position relative to the ball. In these three variants, the term “lateral direction” means a direction in a plane which is essentially perpendicular to a line connecting the proximal shell with the ball and the distal shell. Accordingly, a movement in lateral direction of the proximal shell or the distal shell, respectively, means a movement in said plane. Such a movement enables an adaption of the position of the proximal shell relative to the ball and across the ball relative to the distal shell. Combined with the adjustable biasing element which biases the proximal shell and the distal shell towards each other, this enables to find an optimal position of the ball relatively to the wear surface of the proximal shell and relatively to the wear surface of the distal shell such that the proximal shell and the distal shell may come closest to each other. Consequently, such a movement of the proximal shell or the distal shell, respectively, has the advantage that it enables to correct for small fabrication caused deviations in the shape and size of the ball, the proximal shell and its wear surface as well as of the distal shell and its wear surface. Therefore, the three variants enable to adapt the individual elements of the ball joint optimally to each other and to control the stiffness of the ball joint optimally. Furthermore, in the two variants where only one of the proximal shell and the distal shell is moveable, the additional advantage of a simpler constructed ball joint may be obtained by attaching the other one of the proximal shell and the distal shell to the socket or by constructing the other one of the proximal shell and the distal shell as part of the socket.

Alternatively, neither the proximal shell nor the distal shell may be mounted in the socket moveable in lateral direction relatively to the socket.

If the ball joint comprises a socket, the biasing element is preferably attached to a proximal end of the socket and applies the force to the proximal shell in order to bias the proximal shell and the distal shell towards each other. In this case, the force which is applied to the proximal shell and the ball is counteracted by the distal shell. Accordingly, the required counteracting force acting on the distal shell is conferred from the biasing element to the socket and from the socket to the distal shell. In a preferred variant, the biasing element is attached to a distal end of the socket and applies the force to the distal shell in order to bias the proximal shell and the distal shell towards each other. In this case, the force which is applied to the distal shell and the ball is counteracted by the proximal shell. Accordingly, the required counteracting force acting on the proximal shell is conferred from the biasing element to the socket and from the socket to the proximal shell. Both variants have the advantage that a reliable application of the biasing force is provided.

In a further variant, the biasing element is mounted in the socket. In this variant, the biasing element may for example be placed between the proximal end of the socket and the proximal shell or between a distal end of the socket and the distal shell. In either case, the biasing element applies a force to the respective end of the socket and the respective shell which pushes the respective end of the socket and the respective shell away from each other. In order to bias the proximal shell and the distal shell towards each other, the socket may confer the counteracting force to the other shell. In another example of the same variant, the biasing element may be attached to the socket at a location sidewise to the proximal shell or sidewise to the distal shell, respectively. In this example, the biasing element may apply a force to the respective shell and the socket and the force which is applied to the socket may be conferred from the socket to the other shell, such that the proximal shell and the distal shell are biased towards each other. Accordingly, the advantage of this further variant enables a reliable application of the biasing force, too.

In still another variant, the biasing element may extend from the proximal shell to the distal shell and press the proximal shell and the distal shell towards each other. Hereby, the biasing element may be mounted in the socket or may be arranged outside the socket. Furthermore, this variant may be employed even if the ball joint does not comprise a socket.

Alternatively, the biasing element may be arranged differently.

If the ball joint comprises a socket and if the biasing element is attached to a proximal end of the socket, the biasing element advantageously forms a proximal end of the ball joint. Similarly, if the ball joint comprises a socket and if the biasing element is attached to the distal end of the socket, the biasing element preferably forms a distal end of the ball joint which is exceeded in distal direction only by the arm attached to the ball. Both variants have the advantage that the biasing element is accessible from outside the ball joint such that a simple access is provided for adjusting the force with which the proximal shell and the distal shell are biased towards each other.

Alternatively, if the biasing element is attached to the proximal end of the socket, the biasing element may not form the proximal end of the ball joint, while if the biasing element is attached to the distal end of the socket, the biasing element may not form the distal end of the ball joint. In such a case, the biasing element may for example be covered by some cover.

Advantageously, the biasing element comprises a box section filled with oil or grease, the box section having a thin surface wall which bends depending to a pressure in said box section. This has the advantage that the force exerted by the biasing element is controllable by controlling the pressure of the box section. In a variant, the box section may be filled with some other liquid than oil or grease or may be filled with some gas.

Alternatively, the biasing element may be constructed differently. For example, it may comprise some other means for exerting the force for biasing the proximal shell and the distal shell towards each other. This means may be an elastic element like for example a spring or may be a piezoelectric element which deforms if a voltage is applied. In case of an elastic element, the force may be adjusted for example with a screw, while in case of a piezoelectric element, the force may be adjusted by adjusting the applied voltage.

If the biasing element comprises a box section filled with oil or grease or any other liquid and if the box section has a thin surface wall which bends depending to a pressure in said box section, the biasing element comprises preferably a piston for adjusting the pressure in the box section. This piston may be inserted further into the box section for increasing the pressure in the box section, while it may be pulled out of the box section in order to decrease the pressure in the box section. For example, if the piston provides a screw thread, this insertion and pulling out may be obtained by turning the piston. But the piston may be inserted and pulled out of the box section by different means as well. Independent of this means, the piston has the advantage that the force applied by the biasing element is well controllable and simple to adjust.

Alternatively, the biasing element may not comprise a piston for adjusting the pressure in the box section. Instead of the piston, the pressure may be controlled for example by an external generator.

If the biasing element comprises a box section filled with oil or grease and the box section has a thin surface wall, the proximal shell is preferably mounted on the thin surface wall and pressed by the thin surface wall towards the ball and the distal shell with a force that depends on the pressure in the box section and thus on the bending of the thin surface wall. This has the advantage that independent of whether there is some other element arranged between the thin surface wall and the proximal shell, the force acts straight on the proximal shell.

In a variant, the distal shell is advantageously mounted on the thin surface wall and pressed by the thin surface wall towards the ball and the proximal shell with a force that depends on the pressure in the box section and thus on the bending of the thin surface wall. This has the advantage that independent of whether there is some other element arranged between the thin surface wall and the distal shell, the force acts straight on the distal shell.

In a variant, if the proximal shell is mounted on the thin surface wall, there may be employed one or more intermediate elements between the thin surface wall and the proximal shell. In a further variant, if the distal shell is mounted on the thin surface wall, there may be employed one or more intermediate elements between the thin surface wall and the distal shell. Alternatively, there may be no intermediate elements employed between the thin surface wall and the respective shell.

Advantageously, the wear surface of the distal shell has a shape which, at a distal end of the distal shell close to the opening for passage of the arm, corresponds to a part of a sphere with a same radius as a radius of the ball, the shape opening up towards a proximal end of the distal shell more than a sphere with the radius of the ball. In one example, the shape of the distal shell's wear surface may correspond to a parabolic shape. In another example, the shape of the distal shell's wear surface may not correspond to a parabolic shape but may correspond to another shape which is opening towards the proximal end of the distal shell more than a sphere with radius of the ball. In both examples, in the assembled ball joint, the ball is seated in the wear surface of the distal shell like being seated in a chute. This has the advantage that in the assembled ball joint, where the ball is located between the proximal shell and the distal shell, the ball is kept by the part of the wear surface of the distal shell located at the distal end of the wear surface close to the opening for passage of the arm. In this position, the ball cannot get canted or jammed in the wear surface of the distal shell or at the proximal edge of the wear surface because of the chute-like opening of the wear surface. Consequently the shape of the distal shell's wear surface enables an optimal bearing of the ball.

In a preferred variant, the wear surface of the distal shell has a shape which, at an intermediate part of the wear surface, corresponds to a part of a sphere with a same radius as the ball, the shape opening up towards a proximal end of the distal shell more than a sphere with the radius of the ball and the shape closing in towards a distal end of the distal shell less than a sphere with the radius of the ball. Therefore, in the assembled ball joint, the ball is seated in the wear surface of the distal shell and touches only the intermediate part of the wear surface. This intermediate part is not a single point but may be a thin ring or a broader stripe circling at a same height around the wear surface. Accordingly, the shape of the distal shell's wear surface prevents the ball of getting canted or jammed in the wear surface of the distal shell, at the edge of the opening for passage of the arm, or at the proximal edge of the wear surface. Consequently, such a shape of the distal shell's wear surface enables an optimal bearing of the ball.

In a variant, the shape of the distal shell's wear surface corresponds to a part of a sphere with the same radius as the radius of the ball or with a larger radius than the radius of the ball.

Alternatively, the wear surface of the distal shell may have a different shape.

Preferably, the wear surface of the proximal shell has a shape which, at an intermediate part of the wear surface, corresponds to a part of a sphere with a same radius as the ball, the shape opening up towards a distal end of the proximal shell more than a sphere with the radius of the ball and the shape closing in towards a proximal end of the proximal shell less than a sphere with the radius of the ball. Therefore, in the assembled ball joint, the ball is seated in the wear surface of the proximal shell and touches only the intermediate part of the wear surface. This intermediate position is not a single point but may be a thin ring or a broader stripe circling at a same height around the wear surface. Accordingly, the shape of the proximal shell's wear surface prevents the ball of getting canted or jammed in the wear surface of the proximal shell or at the distal edge of the wear surface. Consequently, such a shape of the proximal shell's wear surface enables an optimal bearing of the ball.

In a preferred variant, the wear surface of the proximal shell provides an opening at its proximal end. In this variant, the proximal shell's wear surface has a shape which, at a proximal end of the proximal shell close to the opening, corresponds to a part of a sphere with a same radius as a radius of the ball, the shape opening up towards a distal end of the proximal shell more than a sphere with the radius of the ball. In one example, the shape of the proximal shell's wear surface may correspond to a parabolic shape. In another example, the shape of the proximal shell's wear surface may not correspond to a parabolic shape but may correspond to another shape which is opening towards the distal end of the proximal shell more than a sphere with radius of the ball. In both examples, the ball is seated in the wear surface of the proximal shell like being seated in a chute. This has the advantage that in the assembled ball joint, where the ball is located between the proximal shell and the distal shell, the ball is kept by the part of the proximal shell's wear surface located at the proximal end of the wear surface close to the opening. In this position, the ball cannot get canted or jammed in the wear surface of the proximal shell or at the distal edge of the wear surface because of the chute-like opening of the wear surface. Consequently, such a shape of the proximal shell's wear surface enables an optimal bearing of the ball, too.

Alternatively, the wear surface of the proximal shell may have a different shape.

Independent of the shape of the proximal shell's wear surface, the proximal shell has preferably an opening at its proximal end. This has the advantage that with this opening, the proximal shell may be mounted on some other element. Accordingly, if for example the ball joint comprises a socket and the proximal shell is mounted moveably in the socket, the proximal shell may be mounted on a stud of a flat element, the flat element having a diameter slightly larger than a diameter of proximal shell. This flat element may be moveably mounted in the socket, too. In this case, the flat element prevents the proximal shell of canting with the socket's walls or of getting jammed in the socket because it keeps the proximal shell at some distance from the socket's walls. The same effect may be obtained as well if the flat element is fixedly mounted to the socket and if the opening in the proximal end of the proximal shell provides some clearance when being mounted on the stud of the flat element. In this latter case, the mounting of the flat element may be used for positioning the stud in a centre of the socket such that the proximal shell may be moved by a small distance in all directions perpendicular to the rotation symmetry axis of the proximal shell without getting canted or jammed in the socket.

In a variant, the proximal shell may have a stud at its proximal end. In this case, the proximal shell may be mounted on some other element which provides an opening for the stud of the proximal shell. Accordingly, an arrangement may be employed which has a swapped arrangement of the stud and the opening as compared to the example described before.

Alternatively, the proximal shell may not comprise an opening at its proximal end. In this case, the proximal shell may be fixedly attached to the socket or may be mounted moveably in the socket.

Advantageously, the ball is made of hardened steel. This has the advantage that the ball is hard and cannot be deformed easily when being used in the ball joint. Alternatively, the ball may be made of another material or another material composition. For example, the ball may be made of another metal, of an alloy, of ceramic, of plastic, of Teflon or of some other material. Furthermore, the ball may for example comprise a core made of a first material or composition and may comprise a coating or a thicker layer on its surface which is made of a second material or composition. In this latter case, the coating or layer on the surface of the ball may be optimised for gliding in the wear surfaces of the proximal shell and the wear surface of the distal shell, respectively.

If the ball is made of hardened steel, a surface of the ball is advantageously treated by a Tribobond™ treatment which is done by “the surface Engineers™ ionbond”. In a preferred variant, the surface of the ball is processed by electro chemical machining. In a further preferred variant, the surface of the ball is hard-turned or grinded.

Alternatively, the surface of the ball may be treated with some other treatment or may not be specially treated.

Preferably, the proximal shell and the distal shell are made of hardened steel. This has the advantage that the shells are hard and cannot be deformed easily when being used. In a variant, the proximal shell and the distal shell may be made of another material or another material composition. Also, only one of the proximal shell and the distal shell may be made of hardened steel, while the other of the proximal shell and the distal shell may be made of another material or another material composition. If one of the proximal shell and the distal shell or both the proximal shell and the distal shell are made of another material or composition than hardened steel, the respective shell may for example be made of another metal, of an alloy, of ceramic, of plastic, of Teflon or of some other material. Furthermore, the respective shell may for example comprise a core made from a first material or composition, while its wear surface may be made of a second material or composition. This second material or composition may be optimised for bearing the ball and for enabling an optimal gliding of the ball in the wear surface.

If the proximal shell is made of hardened steel, the wear surface of the proximal shell is preferably processed by electro chemical machining, while if the distal shell is made of hardened steel, the wear surface of the distal shell is preferably processed by electro chemical machining. The electro chemical machining of the wear surface or the wear surfaces has the advantage that the ball is optimally mounted on the respective wear surface.

Alternatively, the wear surface of the proximal shell and the distal shell, respectively, may be treated with some other surface treatment or may not be treated specially.

In case the ball joint comprises a socket, the socket comprises preferably a reinforcement ring made of carbon fibre for preventing the socket of opening up if the arm with the ball is pulled in distal direction. This reinforcement ring may be arranged at an outer circumference of the socket, inside the socket or within a sidewall of the socket. It has the advantage that it enables a stable and durable bearing of the ball in the socket since it prevents the socket of opening up if the arm with the ball is pulled in distal direction. In a variant, the reinforcement ring is made of a different material than carbon fibre. For example, it may be made of some other epoxy or of metal. Independent of the material the reinforcement ring is made of, it is advantageously arranged on or in the socket such that the ball is located within the perimeter of the reinforcement ring in the centre of the ring or slightly in proximal direction to the centre of the ring. Such an arrangement of the reinforcement ring has the advantage that its effect of preventing the socket of opening up if the arm with the ball is pulled in distal direction is optimised. But in a variant, the reinforcement ring may be arranged differently as well.

Alternatively, the socket may not comprise a reinforcement ring. Such an alternative is advantageous if the ball joint is not exposed to tensile stress because in that case the ball joint can be fabricated simpler and less cost-intensive.

Other advantageous embodiments and combinations of features come out from the detailed description below and the totality of the claims.

### BRIEF DESCRIPTION OF THE DRAWINGS

The drawings used to explain the embodiments show:

FIG. 1 A ball joint according to the invention,

FIG. 2 a cross section through the ball joint,

FIG. 3 a schematic view of a cut through a proximal shell of the ball joint seen from the same perspective as the cross section shown in FIG. 2, and

FIG. 4 a schematic view of a cut through a distal shell of the same ball joint seen from the same perspective as the cross section shown in FIG. 2.

In the figures, the same components are given the same reference symbols.

### PREFERRED EMBODIMENTS

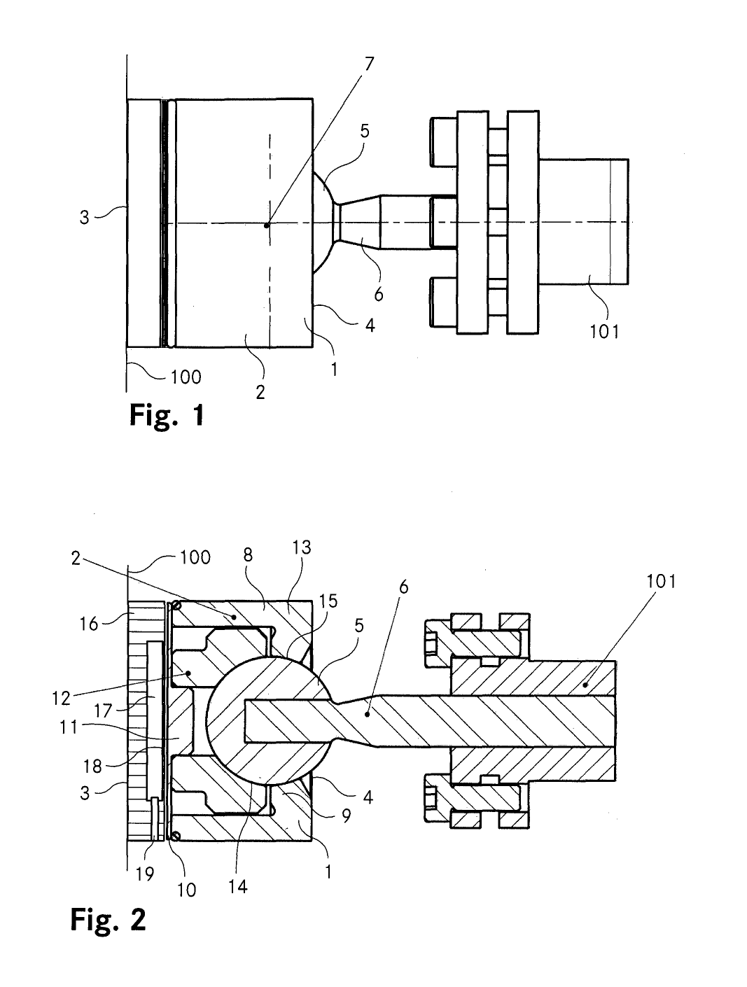

FIG. 1 shows a ball joint 1 according to the invention. This ball joint 1 comprises a socket 2 and a ball 5, both made of hardened steel. The ball 5 is mounted inside the socket 2 and carries an arm 6 which is attached to the ball 5. It can be rotated inside the socket 2 around a point 7 such that the arm 6 is pivoted in space or turned around its longitudinal axis. In such a movement, a position of the ball 5 remains the same in the socket 2. Accordingly, the ball 5 is rotated on its position if the arm 6 is pivoted in space or turned around its longitudinal axis.

In the example shown in FIG. 1, the ball joint 1 is attached to a surface 100 such that the socket 2 is fixed relative to the surface 100. For this reason, the surface 100 is used as a reference in the sense that a face or end of the ball joint 1 which faces towards the surface 100 is called a proximal face or end, respectively, while a face or end of the ball joint 1 which faces away from the surface 100 is called a distal face or end, respectively.

Referring to this reference system, the ball joint 1 is attached with its proximal end 3 to the surface 100, while a distal end 4 of the socket 2 faces away from the surface 100. This distal end 4 of the socket 2 provides an opening through which the arm 6 is passed from the ball 5 out of the socket 2. Since this opening is larger than a diameter of the arm 6, the arm 6 can be pivoted in space relative to the socket 2 and thus relative to the surface 100. Therefore, with the help of the ball joint 1, some other component 101 which is attached to a distal end of the arm 6 can be moved relative to the surface 100.

FIG. 2 shows a cross section through the ball joint 1 from FIG. 1. This cross section is a cut through the socket 2, the ball 5 and the arm 6 and reaches from the proximal end 3 of the ball joint 1 and thus the surface 100 to a distal end of the ball joint 1, where the component 101 is attached to the arm 6. Accordingly, the cross section illustrates the construction of the socket 2 and the bearing of the ball 5 in the socket 2.

The socket 2 comprises a hollow, tube-like member 8 which has an inner diameter which is larger than a diameter of the ball 5. This tube-like member 8 is oriented with its rotation symmetry axis perpendicular to the surface 100 to which the ball joint 1 is attached to. A distal end of the tube-like member 8 forms the distal end 4 of the socket 2. Therefore, the opening in the distal end 4 of the socket 2 which has been described before is an opening in the tube-like member 8. A border 9 of this opening is formed in that at the distal end of the tube-like member 8, the side wall of the tube-like member 8 is curved inwards such that a diameter of the opening is smaller than a diameter of the ball 5. Therefore, the border 9 which is curved inwards at the distal end of the tube-like member 8 maintains the ball 5 inside the tube-like member 8 and thus inside the socket 2. For this reason, the border 9 comprises on its inner face a wear surface 15 which acts together with the ball 5. Accordingly, the socket 2 and the tube-like member 8 with the border 9 form a distal shell 13 of the ball joint 1.

A proximal end of the tube-like member 8 lies in a plane perpendicular to the rotation symmetry axis of the tube-like member 8. Aligned in this plane, a thin plate 10 made of steel, hardened steel or aluminium is mounted to the proximal end of the tube-like member 8. This plate 10 has a circular shape and fits on the tube-like member 8 without overshooting an outer circumference of the tube-like member 8. On a distal side of the plate 10, the plate 10 comprises a stud 11 with a circular cross section which is arranged in a centre of the plate 10 and which points in distal direction towards the ball 5 inside the tube-like member 8. On this stud 11, a proximal shell 12 made of hardened steel is mounted. This proximal shell 12 is rotation symmetric and is oriented with its rotation symmetry axis parallel to the rotation symmetry axis of the tube-like member 8. On its distal face, it provides a wear surface 14 for acting together with the ball 5.

The proximal shell 12 is mounted inside the tube-like member 8 such that the ball 5 is kept between the proximal shell 12 and the distal shell 13. For optimising the bearing of the ball 5, the mounting of the proximal shell 12 on the stud 11 provides some clearance for the proximal shell 12 to move relative to the tube-like member 8 in a direction perpendicular to the rotation symmetry axis of the proximal shell 12. Accordingly, the proximal shell 12 may adapt its position relative to the tube-like member 8 and thus relative to the distal shell 13 in order to correct for deviations of the distal shell 13 and its wear surface 15, the ball 5 and the proximal shell 12 and its wear surface 14. Furthermore, the bearing of the ball 5 is optimised in that a surface of the ball 5 is treated with a Tribobond′ treatment and in that the wear surface 14 of the proximal shell 12 and the wear surface 15 of the distal shell 13 are both processed by electro chemical machining.

At the proximal end 3 of the ball joint 1, a biasing element 16 is attached to a proximal face of the plate 10. This biasing element 16 is made of steel, hardened steel or aluminium and has a disk-like shape with two major surfaces and a circular circumference. Its diameter is about the same as the diameter of the plate 10 and the tube-like member 8. Close to its outer circumference, the biasing element 16 provides holes reaching from one of its major surfaces to the other of its major surfaces. Through these holes, screws (not shown) are guided from a proximal major surface of the biasing element 16 to a distal major surface of the biasing element 16. Furthermore, these screws are guided through holes in the plate 10 into holes with screw threads in a proximal front face of the tube-like member 8. By these screws, the biasing element 16, the plate 10 and the tube-like member 8 are attached together to form the socket 2.

Inside the biasing element 16 is a box section 17 located. This box section 17 has a disk-like shape and is oriented with its major surfaces parallel to the major surfaces of the biasing element 16. It is arranged close to the distal major surface of the biasing element 16 such that in distal direction, only a thin surface wall 18 separates the box section 17 from the outside of the biasing element 16. A thickness of this thin surface wall 18 is chosen such that the thin surface wall 18 is bent outside in distal direction if a pressure is applied inside the box section 17. Consequently, an increased pressure in the box section 17 leads to a bended thin surface wall 18 and presses the plate 10 and the proximal shell 12 towards the ball 5 and the distal shell 13.

In order to apply the pressure inside the biasing element 16, the biasing element 16 provides a valve (not shown) for filling the box section 17 with oil or grease and a piston 19 which reaches from an outside of the biasing element 16 to the box section 17. Through the valve, the box section 17 is filled with oil or grease when the ball joint 1 is assembled. Once the ball joint 1 is assembled and the box section 17 filled, the valve is closed and the pressure inside the box section 17 is controlled by the piston 19 which has a screw thread and which can be screwed inwards for increasing the pressure in the box section 17 and outwards for decreasing the pressure in the box section 17. Therefore, by screwing the piston 19 inwards or outwards, the bending of the thin surface wall 18 and thus the pressure on the plate 10 and the proximal shell 12 can be controlled. Accordingly, the stiffness of the ball joint 1 is controllable by the piston 19.

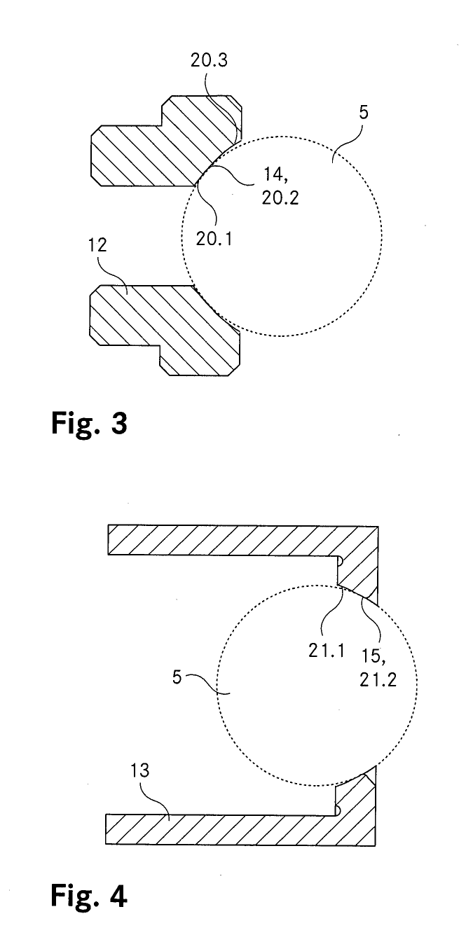

FIG. 3 shows a schematic view of a cut through the proximal shell 12 seen from the same perspective as the cross section shown in FIG. 2. It illustrates the shape of the proximal shell 12's wear surface 14 and compares it to the shape of the ball 5 which is shown as a dashed circle.

The proximal shell 12's wear surface 14 is divided into a proximal part 20.1, an intermediate part 20.2 and a distal part 20.3. The intermediate part 20.2 of the wear surface 14 corresponds to a part of a sphere with a same radius as the ball 5. In distal direction of the intermediate part 20.2, the distal part 20.3 of the wear surface 14 is located. This distal part 20.3 has a shape which is similar to a part of a sphere with a radius that is larger than the radius of the ball 5. Accordingly, in distal direction, the distal part 20.3 opens up more than the intermediate part 20.2 such that the ball 5 touches the wear surface 14 at the intermediate part 20.2 and diverges from the ball 5 at the distal part 20.3. Similarly, the proximal part 20.1 of the wear surface 14 is located in proximal direction of the intermediate part 20.2 and has a shape similar to a part of a sphere with a radius which is smaller than the radius of the ball 5. Accordingly, in proximal direction, the proximal part 20.1 closes in less than the intermediate part 20.2 such that the ball 5 touches the wear surface 14 at the intermediate part 20.2 and diverges from the ball 5 at the proximal part 20.1. This particular shape of the wear surface 14 where the ball 5 touches only the intermediate part 20.2 of the wear surface 14 prevents the ball 5 of getting canted or jammed in the wear surface 14 of the proximal shell 12 or in the proximal or distal edge of the wear surface 14 of the proximal shell 12. This effect is independent on whether the changes from the intermediate part 20.2 to the distal part 20.3 and from the intermediate part 20.2 to the proximal part 20.1 are sharp bends or continuous changes.

FIG. 4 shows a schematic view of a cut through the distal shell 13 seen from the same perspective as the cross section shown in FIG. 2. It illustrates the shape of the distal shell 13's wear surface 15 and compares it to the shape of the ball 5 which is shown as a dashed circle.

The distal shell 13's wear surface 15 is divided into a proximal part 21.1 and a distal part 21.2. The distal part 21.2 of the wear surface 15 corresponds to a part of a sphere with a same radius as the ball 5. The distal border of the distal part 21.2 and thus of the wear surface 15 is topped off and made round, while in proximal direction of the distal part 21.2, the proximal part 21.1 of the wear surface 15 is located. This proximal part 21.1 has a shape which is similar to a part of a sphere with a radius that is larger than the radius of the ball 5. Accordingly, in proximal direction, the proximal part 21.1 opens up more than the distal part 21.2 such that the ball 5 touches the wear surface 15 at the distal part 21.2 and diverges from the ball 5 at the proximal part 21.1. Accordingly, the ball 5 is prevented of getting canted or jammed in the proximal or the distal edge of the wear surface 15 of the distal shell 13. This effect is independent on whether the change from the distal part 21.2 to the proximal part 21.1 is sharp bend or a continuous change.

The invention is not limited to the embodiment of the ball joint 1 as described above. For example, the wear surfaces of the proximal shell and the distal shell may be shaped differently, may be treated differently or may not be specially treated. Furthermore, the proximal shell and the distal shell may be made from another material or material composition. Also, they may carry a coating or a layer of a different material or composition at the position of their respective wear surface for optimising the bearing of the ball.

Similarly, the ball may have a surface which is treated by a different treatment or may have no special surface treatment. Also, the ball may be made from a different material or material composition and may carry a coating or a layer of a different material or composition than its core.

Differing from the ball joint 1 described above, the distal shell may for example be a separate element and may be attached to the socket or may be mounted in the socket. Furthermore, the shape of the socket, the proximal shell and the distal shell may differ from the ones shown in the figures. Similarly, the shape of the arm and its neck where it is attached to the ball may differ from the shape shown in FIGS. 1 and 2. For example, the shape of the neck and the shape of the opening in the distal end of the socket may be adapted to the specific needs of the ball joint such that a required range of possible arm movements is provided.

Furthermore, the biasing element may be mounted inside the socket instead of being arranged at the proximal end of the socket and thus forming a part of the socket. Furthermore, the biasing element may be constructed differently from one shown in FIG. 2. For example, the thin surface wall which bends depending on the pressure in the box section may be made from a separate element and may be soldered, glued or screwed to the rest of the biasing element in order to close the box section. Additionally, the plate with the stud may be constructed as the thin surface wall and may be soldered or glued to the rest of the biasing element instead of being constructed as a separate element.

In contrast to the embodiment of the ball joint 1, the biasing element may not provide a box section filled with a gas or liquid but may comprise an elastic element like for example a spring. In such a case, the force applied by the biasing element may be controlled in that a pretention of the elastic element is controlled by a screw. Furthermore, any ball joint according to the invention may be employed differently than shown in the FIGS. 1 and 2. For example, the socket may be screwed, glued, soldered or mounted differently to a surface or may even be buried inside the surface.

In summary, it is to be noted that the described ball joint according to the invention can be produced in a number such that all the ball joints have a same compression of the ball between the inner and the outer bearing and thus have a same stiffness.

1. A ball joint comprising a ball with an attached arm, a proximal shell having a wear surface, and a distal shell having a wear surface and having an opening for passage of said arm, wherein
a) said ball is held between said wear surface of said proximal shell and said wear surface of said distal shell,
b) said arm is passed through said opening in said distal shell, and wherein
c) said ball joint comprises a biasing element by which said proximal shell and said distal shell are biased with a force towards each other,
characterised in that said biasing element is adjustable in order to adjust said force with which said proximal shell and said distal shell are biased towards each other.

2. The ball joint according to claim 1, characterised in that said ball joint comprises a socket and in that said ball, said wear surface of said proximal shell and said wear surface of said distal shell are arranged in said socket.

3. The ball joint according to claim 2, characterised in that said socket and said distal shell with said opening for passage of said arm are made from a same one piece.

4. The ball joint according to claim 2, characterised in that said proximal shell is an element which is mounted in said socket.

5. The ball joint according to claim 2, characterised in that said proximal shell is movable in lateral direction relatively to said socket for adjusting its position relative to said ball.

6. The ball joint according to claim 2, characterised in that said biasing element is attached to a proximal end of said socket and applies said force to said proximal shell in order to bias said proximal shell and said distal shell towards each other.

7. The ball joint according to claim 6, characterised in that said biasing element forms a proximal end of said ball joint.

8. The ball joint according to claim 1, characterised in that said biasing element comprises a box section filled with oil or grease, said box section having a thin surface wall which bends depending to a pressure in said box section.

9. The ball joint according to claim 8, characterised in that said biasing element comprises a piston for adjusting said pressure in said box section.

10. The ball joint according to claim 1, characterised in that said wear surface of said distal shell has a shape which, at a distal end of said distal shell close to said opening for passage of said arm, corresponds to a part of a sphere with a same radius as a radius of said ball, said shape opening up towards a proximal end of said distal shell more than a sphere with said radius of said ball.

11. The ball joint according to claim 1, characterised in that said wear surface of said proximal shell has a shape which, at an intermediate part of said wear surface, corresponds to a part of a sphere with a same radius as said ball, said shape opening up towards a distal end of said proximal shell more than a sphere with said radius of said ball and said shape closing in towards a proximal end of said proximal shell more than a sphere with said radius of said ball.

12. The ball joint according to claim 1, characterised in that said proximal shell has an opening at its proximal end.

13. The ball joint according to claim 1, characterised in that said proximal shell and said distal shell are made of hardened steel.

14. The ball joint according to claim 1, characterised in that said ball is made of hardened steel.

15. The ball joint according to claim 14, characterised in that said wear surface of said proximal shell and said wear surface of said distal shell are processed by electro chemical machining.

16. The ball joint according to claim 2, characterised in that said socket comprises a reinforcement ring made of carbon fibre for preventing said socket of opening up if said arm with said ball is pulled in distal direction.
